(19) United States
(12) Patent Application Publication
(10) Pub. No.: US 2008/0171239 A1
(43) Pub. Date: Jul. 17, 2008

(54) SYSTEMS AND METHODS FOR PROTECTING A FUEL CELL

(75) Inventors: Gerry Tucker, Pleasanton, CA (US); Robert D. Richardson, Danville, CA (US); Ian W. Kaye, Livermore, CA (US); Joseph Norman Allen, Fairfield, CT (US)

Correspondence Address: BEYER WEAVER LLP, P.O. BOX 70250, OAKLAND, CA, 94612-0250, US

(73) Assignee: ULTRACELL CORPORATION, Livermore, CA (US)

(21) Appl. No.: 11/830,665

(22) Filed: Jul. 30, 2007

Related U.S. Application Data
(63) Continuation of application No. 11/346,547, filed on Feb. 1, 2006.
(60) Provisional application No. 60/649,638, filed on Feb. 2, 2005.
(60) Provisional application No. 60/688,468, filed on Jun. 7, 2005.

(51) Int. Cl. H01M 8/04

(52) U.S. Cl. 429/13

(57) ABSTRACT

The invention relates to hybrid fuel cell systems that protect a fuel cell with a second electrical energy source. The second electrical energy source powers a load to prevent the fuel cell from witnessing stoichiometric levels that may lead to reductions in fuel cell performance or health. The hybrid fuel cell system includes an electrical circuit that electrically initiates the electrical energy source to provide power to the load in response to detecting a potential stoichiometric disturbance for the fuel cell.

### CROSS-REFERENCE TO RELATED APPLICATIONS

This application is a continuation and claims priority under 35 U.S.C. §120 from U.S. patent application Ser. No. 11/346,547 filed Feb. 1, 2006 and entitled “Systems and Methods for Protecting a Fuel Cell,” which claims priority under 35 U.S.C. § 119(e) to i) U.S. Provisional Patent Application No. 60/649,638 filed on Feb. 2, 2005, and ii) U.S. Provisional Patent Application No. 60/688,468 filed on Jun. 7, 2005; each of the patent applications listed above is incorporated by reference in its entirety for all purposes.

### FIELD OF THE INVENTION

The present invention relates to fuel cell technology. In particular, the invention relates to hybrid fuel cell systems and methods that include a fuel cell and a battery that dynamically power a load to protect the fuel cell.

### BACKGROUND OF THE INVENTION

Consumer electronics devices and other electrical power applications currently rely on lithium ion and other battery technologies. The battery technologies represent a mature and trusted technology, but do not provide sufficient longevity for many users and electronics devices.

A fuel cell electrochemically combines hydrogen and oxygen to produce electricity. Portable fuel cell systems promise to extend usage durations for electronics devices; a single fuel cartridge may provide enough fuel to power a portable electronics device up to a full day (or longer), and a user need only replace a depleted fuel cartridge with a fueled cartridge to extend usage. This frees a user from the limits of battery recharging, such as proximity to an AC power.

Portable fuel cell systems are desirable but not yet commercially available. As with adoption of any new technology, fuel cells need to gain consumer confidence related to their reliability. Performance of some fuel cells may suffer when stoichiometry in the fuel cell escapes predetermined operating limits. Fuel cells are still being implemented and tested in new scenarios that continually pose various stoichiometric management issues. While portable fuel cell systems have been built and tested, consumer confidence and commercial adoption requires any fuel cell reliability questions to be resolved before broad commercial adoption ensues.

### SUMMARY OF THE INVENTION

The present invention relates to hybrid fuel cell systems that protects a fuel cell with a second electrical energy source. The second electrical energy source powers a load to prevent the fuel cell from witnessing stoichiometric levels that may lead to reductions in fuel cell performance or health. The hybrid fuel cell system includes an electrical circuit that electrically initiates the electrical energy source to provide power to the load in response to detecting a potential stoichiometric disturbance for the fuel cell. One or more sensors may be used to detect the potential stoichiometric disturbance, such as a voltage or current sensor on the output of the fuel cell that detects if the output voltage for the fuel cell may reach an undesirable level.

In one aspect, the present invention relates to a method of protecting a fuel cell that generates electrical energy used by a load. The method includes detecting a stoichiometric disturbance for the fuel cell. The method also includes, in response to detecting the stoichiometric disturbance, electrically initiating an electrical energy source to provide electrical power to the load. The method further includes maintaining oxygen and hydrogen flow to the fuel cell while the electrical energy source provides electrical power to the load.

In one embodiment, the method also electrically disconnects the load from the fuel cell and maintains oxygen and hydrogen flow to the fuel cell while the fuel cell is electrically disconnected from the load.

In another aspect, the present invention relates to computer readable medium that includes instructions for protecting a fuel cell that generates electrical energy used by a load.

In yet another aspect, the present invention relates to a hybrid fuel cell system for providing power to a load. The hybrid fuel cell system includes a fuel cell configured to produce electrical energy using hydrogen. The hybrid fuel cell system also includes an electrical energy source and an electrical circuit configured to initiate the electrical energy source to provide electrical power to the load in response to detecting a stoichiometric disturbance for the fuel cell.

In another aspect, the present invention relates to a hybrid fuel cell system that includes a passthrough battery. The passthrough battery is adapted to couple to an internal connection of a power management system for the electronics device, includes an external port for interfacing with a power line from the fuel cell, and includes a wiring harness that permits electrical energy provided by the fuel cell to pass to the internal connection of the power management system.

These and other features of the present invention will be described in the following description of the invention and associated figures.

### BRIEF DESCRIPTION OF THE DRAWINGS

FIG. 1A illustrates a hybrid power system in accordance with one embodiment of the present invention.

FIG. 1B illustrates a hybrid power system in accordance with another embodiment of the present invention.

FIGS. 2A-2C shows switching states of a hybrid fuel cell system in accordance with another embodiment of the present invention.

FIGS. 3A and 3B show power management of a hybrid fuel cell system using three power management states in accordance with one embodiment of the present invention.

FIG. 4A shows a series/parallel hybrid system in accordance with another embodiment of the present invention.

FIG. 4B shows a hybrid fuel cell system in accordance with another embodiment of the present invention.

FIG. 5 shows a method for starting up a hybrid fuel cell system in accordance with one embodiment of the present invention.

FIG. 6 shows a method for operating a hybrid fuel cell system in accordance with one embodiment of the present invention.

FIG. 7 describes the fuel cell recovery in FIG. 6 when the battery powers the load.

FIG. 8A shows exemplary polarization curve for a fuel cell in accordance with a specific embodiment of the present invention.

FIG. 8B shows another exemplary polarization curve that compensates for low-voltage usage of a fuel cell in accordance with a specific embodiment of the present invention.

FIG. 9A illustrates an exemplary fuel cell system for producing electrical energy in accordance with one embodiment of the present invention.

FIG. 9B illustrates schematic operation for the fuel cell system of FIG. 9A in accordance with a specific embodiment of the present invention.

FIG. 10A illustrates a passthrough battery situated in the battery bay of a laptop computer in accordance with one embodiment of the present invention.

FIG. 10B shows internal components of the passthrough battery of FIG. 10A and laptop computer in accordance with a specific embodiment of the present invention.

### DETAILED DESCRIPTION OF THE PREFERRED EMBODIMENTS

The present invention is described in detail with reference to a few preferred embodiments as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

A fuel cell electrochemically converts hydrogen and oxygen to water, generating electrical energy (and sometimes heat) in the process. There are many different types of fuel cells; each type may employ a different means of electrochemically producing power, operate in a different temperature range, and use a different fuel. In a phosphoric acid fuel cell (PAFC) for example, an anode splits hydrogen (by means of an electro catalyst) into protons and electrons. The protons conduct through an acid electrolyte to a cathode, while the electrons conduct via metal conductors to the cathode. At the cathode, the protons and electrons combine with oxygen in the presence of a cathode catalyst to produce water vapor (and electricity since the voltage on the charge decreases relative to when the electrons were freed form the hydrogen). For some fuel cells, the generated potential for this reaction is about 0.6V. Solid oxide fuel cells (SOFC), on the other hand, generate oxygen ions at the cathode, which conduct through an oxide electrolyte to an anode where they combine to form water. PAFCs operate at around 140-220 degrees Celsius, while SOFCs operate at between about 500 and about 900 degrees Celsius.

One similarity with many fuel cell types is a need to maintain stoichiometric balance. A fuel cell operates within set and predetermined electrical and chemical conditions. Stoichiometrically, a fuel cell uses an inlet flow of fuel and air proportional to electrical energy output. If a fuel cell witnesses a transient spike of current or voltage, then the fuel cell needs a concurrent increase in fuel and air.

The inventors have discovered numerous conditions in which a fuel cell may be damaged by failing to maintain stoichiometric balance. Some fuel cells may be damaged if their stack receives too little fuel and air relative to the amount of electrical power drawn from the fuel cell. The cells in many stacks are connected in series. In order for a stack to operate correctly, each cell relies on its neighboring cell to remain functional. Thus, if one cell fails, the entire stack and fuel cell may be compromised.

When a fuel cell stack operates too far above or too far below its stoichiometric limits of performance, such as when providing electrical output above its maximum rated voltage or current (e.g., when handling a current spike from a load), there is a possibility of an individual cell or two to “go negative”. This means that a cell in the stack can no longer sustain a reaction rate commensurate with the rest of the cells in the stack, typically because it is not getting enough fuel or air. When this happens, electrochemistry dictates that some other reaction take place to generate current that the stack is properly producing. Under these conditions in a PEM fuel cell for example, graphite in the electrodes can be irreversibly oxidized to CO₂, instead of hydrogen being oxidized to water. If this condition happens for a long enough time, the cell(s) that have “gone negative” will be damaged beyond repair and will have to be replaced before the stack can operate properly again.

The inventors have discovered that there is a wide array of different disturbances in practical implementation of a fuel cell that may lead to such stoichiometric imbalances and threaten the health of the fuel cell. In response, the inventors have developed hybrid electrical systems and methods that generically protect a fuel cell from chemical and electrical disturbances—and maintain stoichiometric balance and health of a fuel cell—despite wide variance in the types of disturbances. The hybrid electrical systems and methods are useful, for example, to protect a fuel cell from witnessing a voltage that is too low or too high.

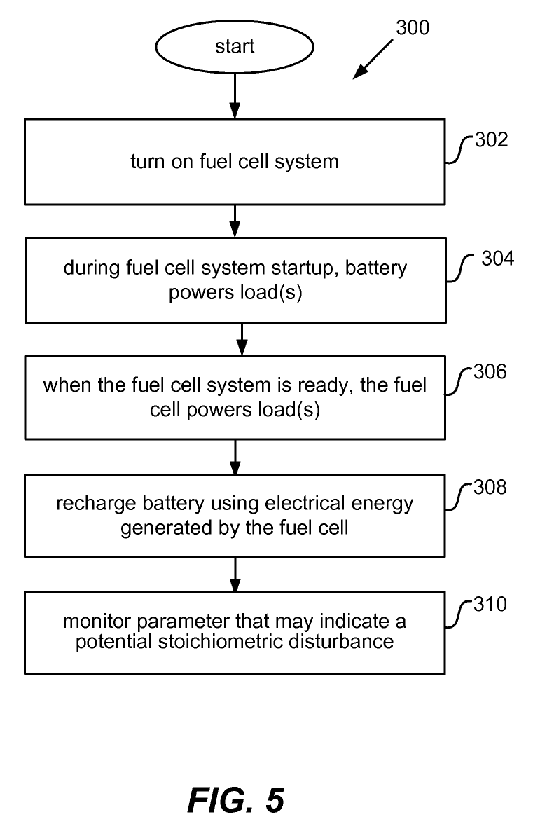

In general, a stoichiometric disturbance refers to any event that may lead to a stoichiometric imbalance or threaten the health of the fuel cell. Exemplary stoichiometric disturbances may include an event that causes fuel cell output voltage to drop below a predetermined threshold, an event that causes fuel cell output voltage to rise above a high predetermined threshold, an interruption in fuel flow such as an air bubble in the fuel line, etc. Additional stoichiometric disturbances are described below with respect to FIGS. 5-7.

A ‘hybrid’ power system as described herein prevents damage to a fuel cell caused by low cell voltages, excessively high cell voltages, and other stoichiometric disturbances. The hybrid fuel cell system includes both a fuel cell and a secondary electrical energy source. The electrical energy source may include a rechargeable battery pack or capacitor that is selectively engaged to protect the fuel cell. For example, when the fuel cell voltage drops below a predetermined low voltage threshold, the electrical energy source powers the electrical load. When the fuel cell voltage rises above a predetermined high voltage threshold, the electrical energy source shares the electrical load with the fuel cell, which maintains electrical output from the fuel cell below the high voltage threshold.

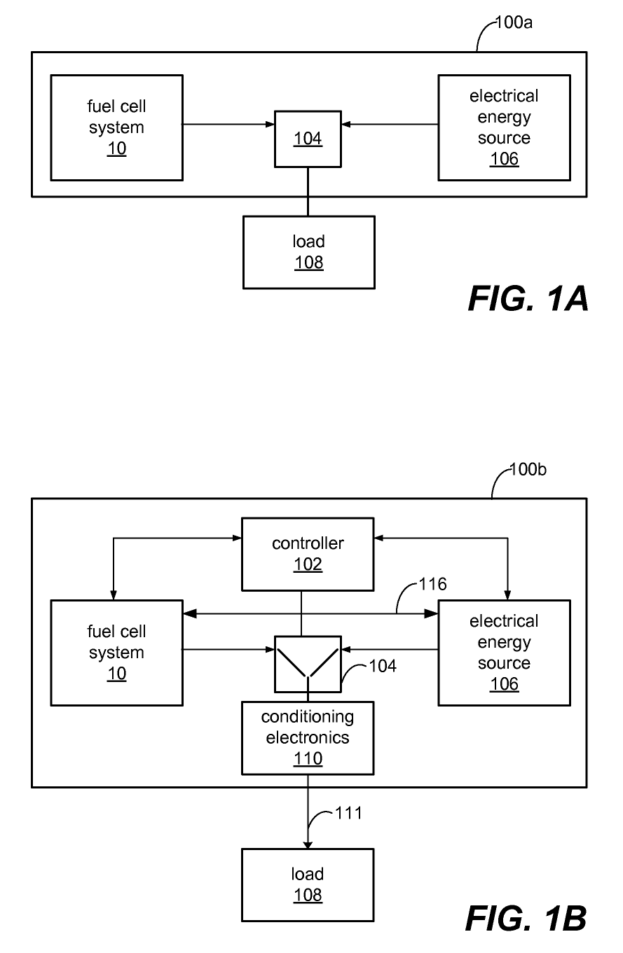

FIG. 1A illustrates a hybrid fuel cell system 100a in accordance with one embodiment of the present invention. System 100a includes a fuel cell 10, electrical energy source 106, electrical circuit 104, and a load 108 coupled to system 100a. Hybrid system 100a offers multiple sources of electrical energy for powering load 108.

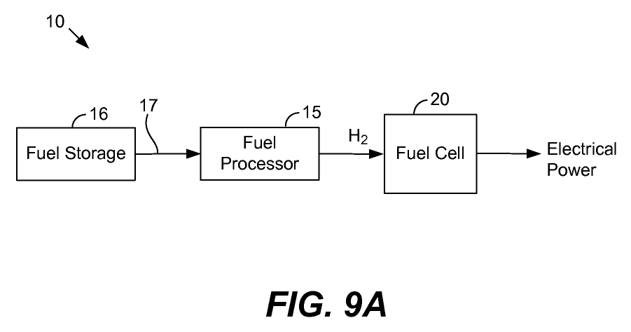

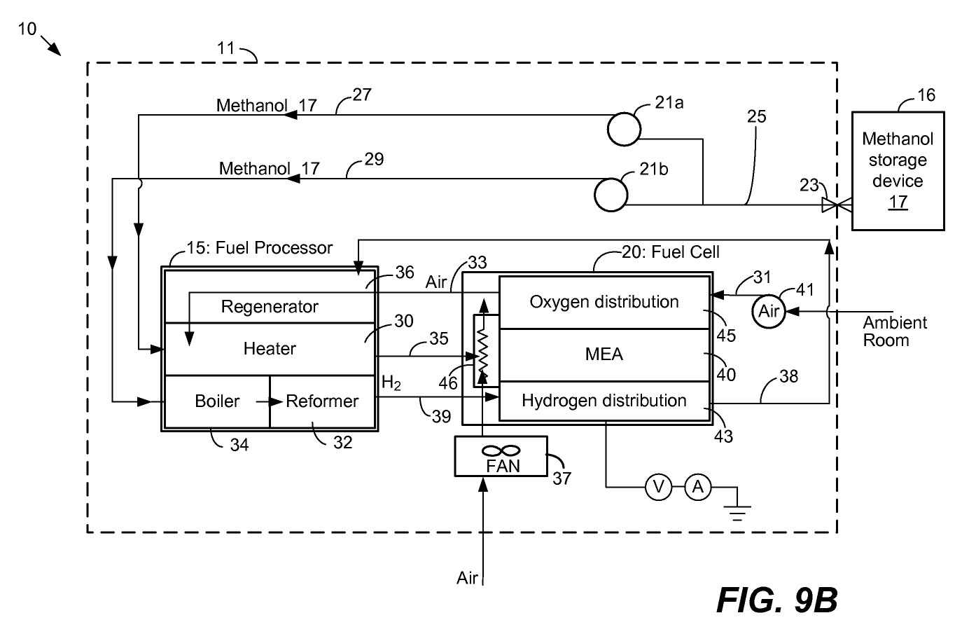

Fuel cell system 10 includes a fuel cell that electrochemically combines hydrogen and oxygen to produce electricity. The ambient air readily supplies oxygen; hydrogen provision, however, calls for a working supply. The hydrogen supply may include a direct hydrogen supply or a ‘reformed’ hydrogen supply. A direct hydrogen supply employs a pure source, such as compressed hydrogen in a pressurized container, or a solid-hydrogen storage system, such as a metal-based hydrogen storage device. A reformed hydrogen supply processes a fuel to produce hydrogen. The fuel acts as a hydrogen carrier, is manipulated to separate hydrogen, and may include a hydrocarbon fuel, hydrogen bearing fuel stream, or any other hydrogen fuel such as ammonia. Currently available hydrocarbon fuels include methanol, ethanol, gasoline, propane and natural gas. Liquid fuels offer high energy densities and the ability to be readily stored and transported. One suitable reformed hydrogen fuel cell system is described below with respect to FIGS. 9A-9B. Other fuel cell systems such as solid oxide fuel cell systems (SOFC) and direct methanol fuel cell systems (DMFC) are also suitable for use in hybrid system 100.

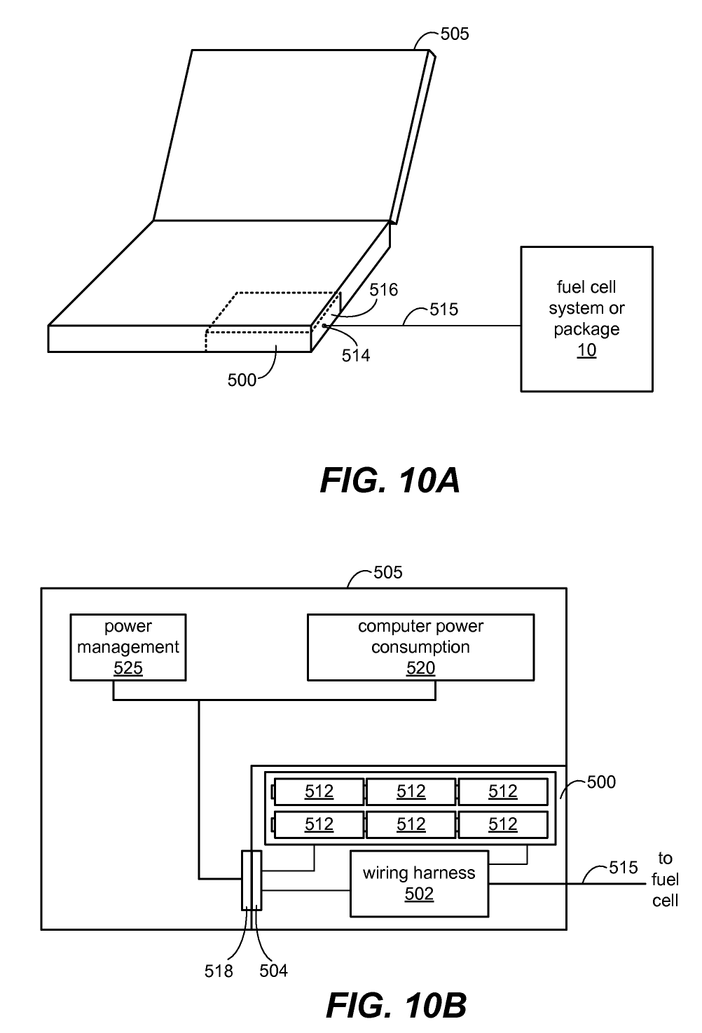

Electrical energy source 106 (or ‘electrical supply’) provides electrical energy on demand. In one embodiment, electrical energy source 106 includes an AC source. A DC source may also be used, such as one or more disposable and/or rechargeable batteries, which are well suited for portable applications. Li-Ion or Ni-Cad batteries are widely available and suitable for use in hybrid system 100. The battery may be included in the fuel cell system 10 as shown (e.g., a portable package that includes a fuel cell and battery) or in an electronics device (e.g., in a laptop, see FIG. 10B). Electrical energy source 106 may be designed and adapted relative to load 108 and a particular application being serviced. More specifically, the size, energy capacity, power performance, voltage levels, and current capacity of source 106 may be tailored to an application. Electrical source 106 may also be designed and configured based on other factors, such as storage cost and portability.

Load 108 refers to one or more devices that receive and use electrical energy. Load 108 may include a single source with transient performance, such as a portable computer, or may include multiple electrically powered devices such as electrical components in a fuel cell system or multiple components in a portable computer or other electronics device that is powered by the hybrid system. For example, load 108 may refer to a radio, camera, computer (e.g., laptop), a device including a motor, combinations of electrical devices, etc. A single load may include multiple components that consume electrical energy. For example, a laptop computer includes multiple components that individually consumes electrical energy such as a CPU, chipset, video subsystem, CD motor, laser for reading or writing to a CD, peripheral device communications, etc. Each component may include transient electrical energy demands. Thus, load 108 may include time-varying electrical energy requirements, either measured as an aggregate (e.g., the laptop) or based on its components (e.g., the motor, which consumes electrical energy intermittently and only when used).

Electrical circuit 104 is configured to control current flow and electrical coupling for the hybrid system. More specifically, circuit 104 electrically initiates electrical energy source 106 to provide electrical power to load 108 in response to detecting a stoichiometric disturbance for the fuel cell in system 10. For example, the electrical circuit 104 may include a controller and switch, one or more diodes, and/or a parallel or series arrangement between the fuel cell in system 10 and electrical energy source 106 that facilitates selective application of the secondary electrical energy source 106. The electrical source 106 may include load 108 shutoff capability that selectively switches or electrically connects/disconnects the fuel cell to the load and/or the secondary electrical energy source to the load.

FIG. 1B illustrates a hybrid power system 100b in accordance with another embodiment of the present invention. System 100b additionally includes controller 102, a switch as the electrical control circuit, conditioning electronics 110 and hybrid line 116.

As shown, circuit 104 includes a switch 104 that electrically connects/disconnects load 108 to: a) a fuel cell in the fuel cell system 10, b) electrical energy source 106, or c) electrical energy source 106 and the fuel cell simultaneously. Switch 104 may include any commercially available or custom-made electrical switch that permits of selective connection of multiple electrical lines. For example, switch 104 may include a solenoid actuated electromechanical switch or a solid state switching device.

Controller 102 communicates with and sends instructions to fuel cell system 10, switch 104 and electrical energy source 106 and regulates electrical performance of system 100. Controller 102 includes a suitably configured processor that executes instructions stored in memory. The controller may include a general purpose processing system operating on stored instructions or a specifically configured controller, either of which are available from a wide variety of vendors. Controller 102 may include any suitable general architecture for performing electrical output control of multiple components, such as a CPU, appropriate interfaces, memory, a bus, etc. The interfaces facilitate the sending and receiving of data between controller 102 and fuel cell system 10 or electrical source 106, and may include, for example, pin configurations provided with a commercially available rechargeable battery. A memory, such as non-volatile RAM and/or ROM, also forms part of controller 102. The memory stores instructions for carrying out methods and steps as described below. One with skill in the art will recognize that there are many different ways in which controller 102 can be configured to regulate operation of hybrid fuel cell system 100.

Conditioning electronics 110 alter electrical output received from the electrical energy source 106 and/or fuel cell system 10 before electrical power delivery to load 108. For example, if the electrical energy source 106 includes an AC source and the load requires DC input of a particular voltage and current, the conditioning electronics includes suitable electronics or a transformer that converts the AC input to the appropriate DC levels. In addition, the conditioning electronics may convert DC output of a battery 106 and DC output of the fuel cell in fuel cell system 10 to DC voltage and current suitable for delivery to load 108. Conditioning electronics 110 include at least one input line that receives electrical energy from power source 106 and fuel cell system 10 and at least one output line 111 for delivering electrical energy to load 108. Output line 111 represents output for hybrid fuel cell system 100b; multiple output lines 111 may be used to power multiple loads 108.

Hybrid lines 116 include one or more electrical lines that communicate electrical energy between one or more components of fuel cell system 10 and electrical energy source 106. The electrical lines may include copper wires and/or electrical lines embedded in circuitry, for example.

In one embodiment, electrical energy source 106 provides electrical energy to fuel cell system 10. This is useful during start-up of the fuel cell system 10 before the fuel cell is ready to generate electrical energy. For example, electrical energy source 106 may power an electrical heater that facilitates warm-up and initiation of a fuel processor and/or fuel cell. Electrical energy provision to fuel cell system 10 may occur until one or more components in the fuel cell system reach a suitable operating temperature or until the fuel cell begins electrical energy generation.

In another embodiment, electrical energy source 106 includes a rechargeable battery and a fuel cell in fuel cell system 10 recharges the rechargeable battery. Typically, recharging occurs when the fuel cell produces more electrical energy than is temporarily needed by load 108 (e.g., the load varies its temporal consumption). The rechargeable battery 106 thus acts as a reservoir for fuel cell system 10 to store electrical energy produced by the fuel cell. This ensures that electrical energy produced by the fuel cell system 10 is efficiently consumed, regardless of temporary fluctuations in electrical demand by load 108. Energy stored in rechargeable battery 106 may then be used for one or more of: combined fuel cell/battery provision for servicing energy spikes in load 108 that are too large for fuel cell system 10 to service alone, electrical energy provision back to fuel cell system 10 during startup of the fuel cell system (e.g., to power a fuel cell system controller or an electrical heater that heats the fuel cell or a fuel processor during start up), to provide power to load 108 when the load requires too little voltage for fuel cell system 10, etc.

In a specific embodiment, electrical energy communicates in both directions between fuel cell system 10 and electrical energy source 106. For example, a rechargeable battery 106 may power one or more components in fuel cell system 10, while the fuel cell recharges the rechargeable battery when appropriate. Cooperatively then, the rechargeable battery provides electrical energy to fuel cell system 10 when needed, while the fuel cell in system 10 charges rechargeable battery 106 when fuel cell system 10 produces electrical energy. Controller 102 regulates this bidirectional relationship according to instructions stored in memory accessible to controller 102. This embodiment is described in further detail below.

In one embodiment, hybrid system 100 is portable. In a specific embodiment, hybrid system 100 weighs less than 5 pounds. Hybrid system 100 then finds wide use in applications where portable electrical energy is required. Military personnel, for example, are increasingly relying upon electronics devices and are often required to spend extended periods of time in remote locations, and would benefit from hybrid system 100.

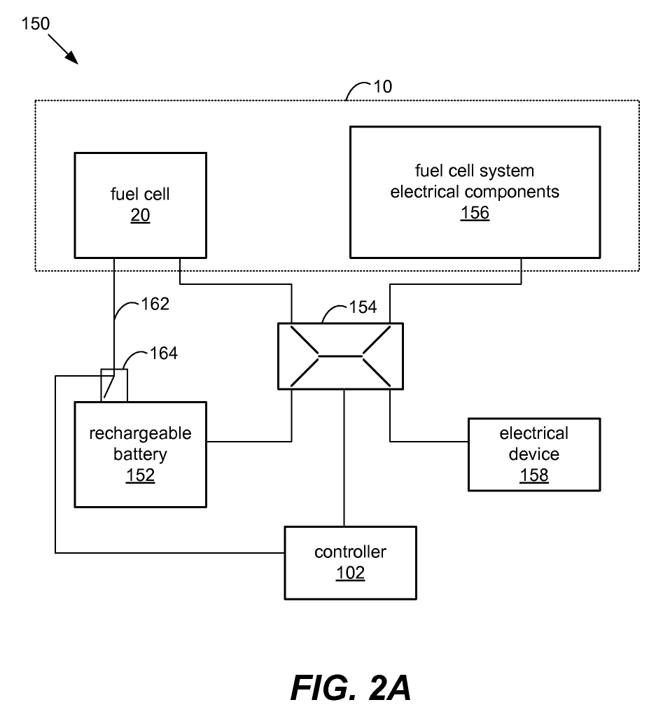

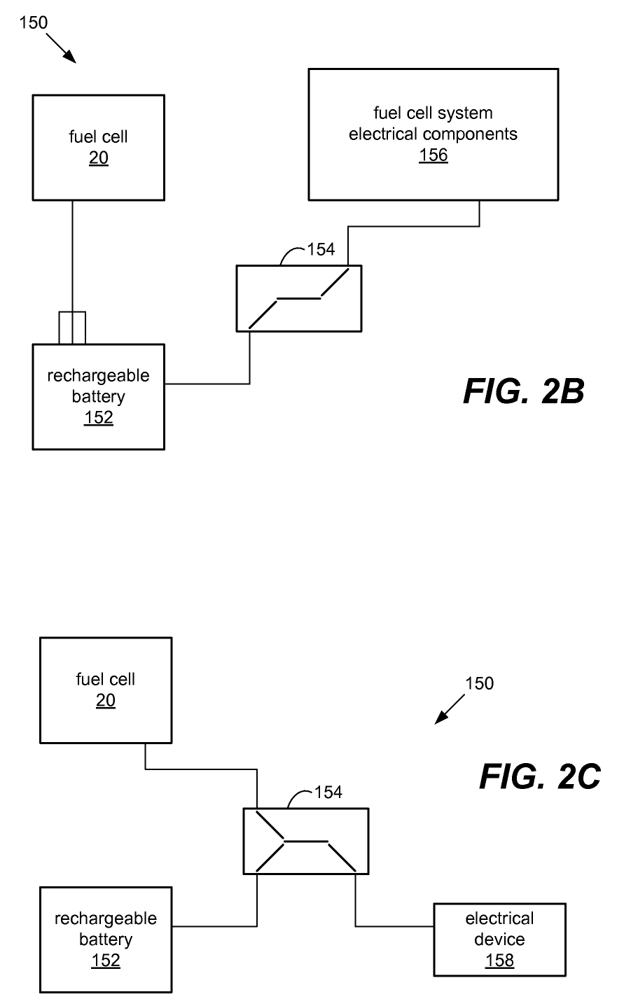

FIGS. 2A-2C shows a hybrid fuel cell system 150 in accordance with another embodiment of the present invention. Hybrid system 150 includes fuel cell 20, rechargeable battery 152, switch 154, fuel cell system electrical components 156, and an electrical device 158.

Electrical device 158 refers to any device or system that uses electrical energy from fuel cell 20 and/or rechargeable battery 152. Exemplary electrical devices may include a laptop computer, handheld computer, cell phone, or radio, for example. Other portable electronics devices are also suitable for use.

Components 156 may include any electrical energy consuming components in a fuel cell system, such as a pump, air compressor, user feature such as an on/off light or user-display, motor, fan, and/or sensor. Exemplary electrical components are described below with respect to the fuel cell system 10 of FIG. 9B.

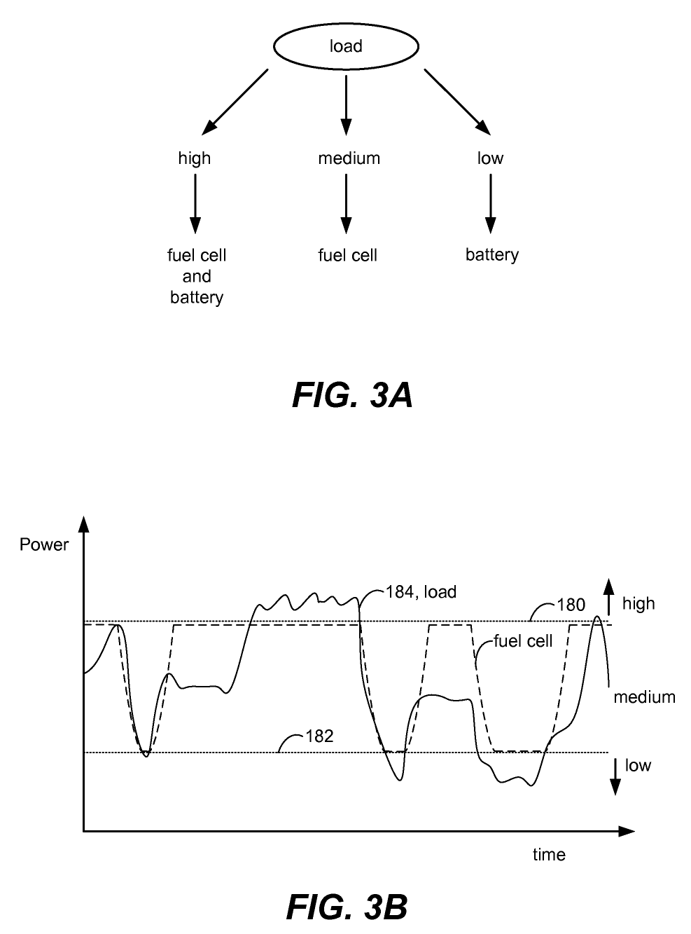

Switch 154 controls electrical connectivity in the system. Specifically, switch 154 controls electrical energy provision from fuel cell 20 and battery 152 to components 156 and load 158. An external controller 102 operates switch 154 according to one or more desired electrical states (see FIG. 3A). FIGS. 2B-2C show two electrical states of hybrid system 150.

The present invention protects a fuel cell by offering multiple states of electrical operation. FIGS. 3A and 3B show protective power management of a hybrid fuel cell system 150 using three states in accordance with one embodiment of the present invention.

A first state, or ‘high’ state, refers to when the load is above a high threshold 180 (FIG. 3B). In this case, the load (device 158 and/or components 156) receives electrical energy from both the fuel cell 20 and battery 152 (FIG. 2C). The fuel cell output may be variably controlled, such as by pulse width modulation (PWM) or variable power DC/DC conversion for example (or other variable power regulation), such that its output is below a threshold limit. Or the fuel cell can be switched in binary mode (i.e. on/off) to maintain an average power below a threshold limit. This allows battery 152 to supply electrical load demands over the high threshold 180 and thereby protect fuel cell 20.

High threshold 180 refers to an upper threshold for fuel cell 20 such as a maximum output power for the fuel cell. The maximum output power refers to a physical maximum for the fuel cell, or some other predetermined output voltage or current such as a lesser maximum output voltage used for safety reasons. As mentioned above, a fuel cell typically has a stoichiometric upper limit for electrical output after which the chemical reactants currently supplied to the fuel cell may be overwhelmed, leading to possible fuel cell damage, e.g., leading to carbon corrosion in a PEM fuel cell. The maximum output power may include the stoichiometric upper limit, or some fraction thereof that provides a measure of safety for the fuel cell. The high electrical threshold 180 thus prevents spikes in the load 108 voltage or current, such as a turning on of a pump in the fuel cell system electrical components 156, from causing the fuel cell 20 to enter an undesirable electrochemical reaction state.

A second state, or ‘low’ state, refers to when the fuel cell voltage is less than its low threshold 182 (FIG. 3B). In this case, the load receives electrical energy only from battery 152 (FIG. 2B).

Low threshold 182 refers to a minimum output electrical threshold for fuel cell 20 such as a minimum output power. The minimum output power refers to a physical minimum for the fuel cell or some other predetermined output voltage or current such as a buffered output voltage used for safety reasons. The minimum output power may thus include a stoichiometric lower limit, or some multiple thereof that provides a measure of safety for the fuel cell. The low electrical threshold 182 thus prevents sudden drops in load voltage or current from causing the fuel cell to enter an undesirable electrochemical reaction state.

A third state, or ‘medium’ state, refers to when the load is between the high electrical threshold 180 and a low electrical threshold 182 (FIG. 3B). In this case, the load receives electrical energy from the fuel cell 20. The medium state is well-suited for use when power consumption by the load is within safe operating ranges for the fuel cell 20.

Thus, the present invention contemplates time varying power consumption for a load powered by a hybrid fuel cell power system. FIG. 3B shows an exemplary energy consumption curve for a load powered by a hybrid fuel cell power system. As shown, curve 184 varies over time and intermittently rises above high electrical threshold 180 and below low electrical threshold 182. The load may comprise one or more electrical devices and components, each of which may vary their power consumption over time.

Returning back to FIG. 2A, hybrid system 150 also includes a line 162 that permits fuel cell 20 to charge rechargeable battery 152. Line 162 also includes a switch 164 operated by controller 102, which determines when the fuel cell charges battery 152. Typically, fuel cell 20 charges rechargeable battery after the load (electrical device 158 and components 156) is satisfied. Thus, if fuel cell 20 generates enough electrical energy to both power the load and deposit energy into battery 152, then controller 102 opens switch 164 to charge the battery. In one embodiment, rechargeable battery 152 includes smarts such as a sensor and digital control and communications that permit controller 102 to communicate with the intelligent battery and let controller 102 know: current battery capacity, when the battery does not need charge (e.g. the battery is at full capacity), or when the battery needs charge. In one embodiment, controller 102 maintains as large a charge in battery 152 as permissible, according to load requirements.

FIG. 2B shows one state where battery 152 powers fuel cell system electrical components 156. Since components 156 may significantly vary their electrical consumption over time (e.g., pumps and compressors), this state uses battery 152 as a buffer to protect fuel cell 20 from highly transient electrical draw by components 156.

FIG. 2C shows a second state where battery 152 and fuel cell 20 cooperatively power electrical device 158. In this instance, battery 152 and fuel cell 20 are disposed in parallel; and battery 152 at least partially buffers the electrical supply from any transient electrical changes imposed by electrical device 158.

Hybrid system 150 may also include one or more sensors that facilitate control. For example, if fuel cell 20 includes high and low electrical thresholds based on output voltage, system 150 may include a voltage sensor on the output of each voltage line from fuel cell 20. In addition, current and voltage sensors may be placed on the load. Voltage and current sensors may also be placed on internal components that require power from the fuel cell or the auxiliary power source to detect power requirements from 156.

Other hybrid systems are contemplated. In another embodiment, a hybrid fuel cell system permits switching between a parallel configuration and a series configuration of a fuel cell and one or more electrical energy sources. The parallel configuration is useful during battery charging by a fuel cell; the series configuration is useful to boost electrical energy provision for load support beyond the internal voltage required for support of components in 156.

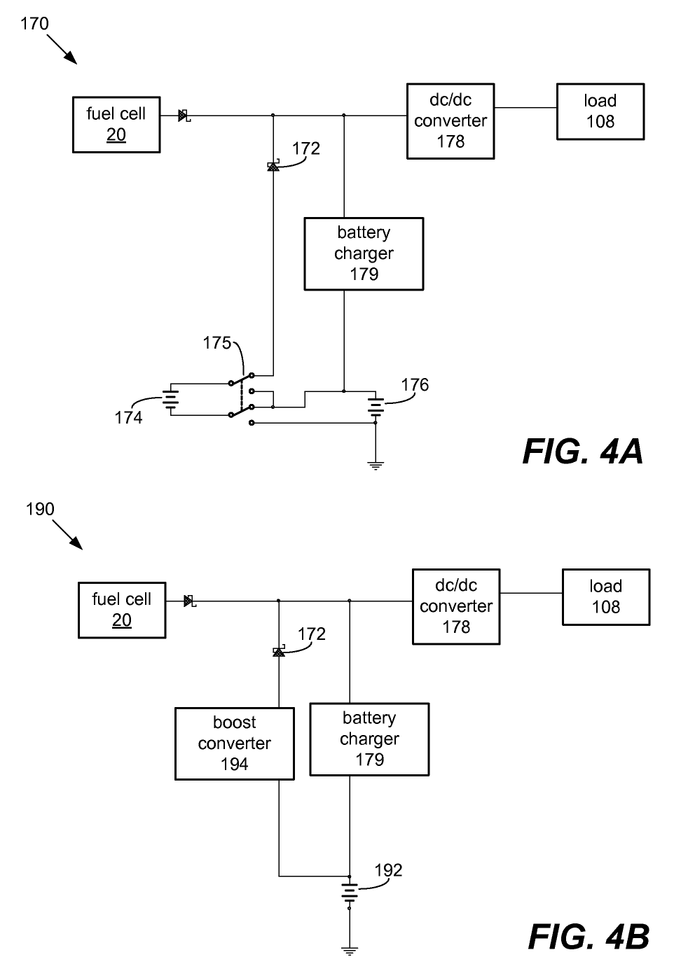

FIG. 4A shows a series/parallel hybrid system 170 in accordance with another embodiment of the present invention.

During steady state operation, switch 175 connects batteries 174 and 176 in parallel relative to the fuel cell. Batteries 174 and 176 are selected such that, in this configuration, the voltage of batteries 174 and 176 remains below the voltage of fuel cell 20, and diode 172 is reversed biased.

When a sensor associated with system 170 detects an undesirable increase in load 108 current, or a reduction in fuel cell 20 voltage, a controller sends an appropriate command and switch 175 connects batteries 174 and 176 in series relative to the fuel cell. The voltage of the series connected batteries 174 and 176 sets a lower limit for the fuel cell voltage in response to load changes, and batteries 174 and 176 assume load 108 entirely, such as during startup or fuel starvation conditions. For example, fuel cell 20 may be deprived of fuel while a user replaces a depleted fuel cartridge with a cartridge containing fuel. In this case, hybrid system 170 prevents the fuel cell 20 output voltage from dropping below the series battery voltage. This effectively clamps output voltage of fuel cell 20 and protects the fuel cell from damage caused by voltage changes initiated by load 108. In addition, this configuration automatically transfers energy provision from fuel cell to battery without intervention by a control system.

The present invention may also modify the output electrical energy. FIG. 4B shows a hybrid fuel cell system 190 in accordance with another embodiment of the present invention. Hybrid system 190 connects fuel cell 20 and battery 192 via an output boost converter 194 that acts as the electrical circuit for controlling electrical energy provision between the fuel cell and the battery. An output of boost converter 194 can be set to a lower limit for the fuel cell 20 output voltage. As long as the fuel cell output voltage is above this lower limit, battery 192 is being charged and does not contribute to load 108. If the fuel cell 20 voltage falls below the lower limit set by the boost converter output, the battery 192 will pick up the load 108 to prevent the fuel cell voltage from falling below the lower limit.

In a specific embodiment, the output boost converter 194 is adjustable. This allows the boost converter output voltage to be adjusted in real time, e.g., by a controller (not shown in FIG. 4B), to reflect changes in the load conditions. This effectively allows the battery and the fuel cell to operate in parallel and share the power required to drive the load.

The present invention also relates to methods for operating a hybrid fuel cell system. To simplify discussion, secondary electrical sources for use with a hybrid system will now be referred to as a battery. It is understood that multiple batteries may be used in addition to other sources of second or electrical energy such as one or more capacitors.

FIG. 5 shows a method 300 for starting up a hybrid fuel cell system in accordance with one embodiment of the present invention. Method 300 begins by turning on the fuel cell system (302). When the system is first turned on or otherwise engaged, the battery powers the load (304), which includes any external loads and any electrical components in the fuel cell system. Electrical energy produced by the battery may be adapted to the receiving electrical component. For example, a power converter may be disposed between the battery and the fuel cell electrical components, while a DC/DC converter may be used to tailor energy provided by the battery that is provided to the load. Components in a fuel cell system powered by the battery during startup may include: one or more pumps that move a fuel from a fuel cartridge into the fuel cell system, a fuel cell system control board or processor, a compressor or other air introduction device, an electrical heater used to heat incoming fuel for a fuel processor, and/or an electrical heater used to preheat the fuel cell.

When the fuel cell and/or fuel cell system is ready, hybrid control switches such that the fuel cell now powers the load(s) (306). Readiness of a fuel cell may be determined by a predetermined operating conditions for the fuel cell. Readiness of the fuel cell system may be determined as a condition of fuel cell readiness, in addition to readiness for a fuel processor or other components in the fuel cell system. For example, hydrogen levels in reformate output by the fuel processor and provided to the fuel cell may need to reach a certain threshold before the fuel cell system is deemed ready. When the fuel cell and/or fuel cell system is ready, the battery switches to a charge mode and stops powering the load(s).

The fuel cell then generates electrical energy for recharging the battery (308). This may occur during steady state operation of the fuel cell, or when possible as determined by electrical output of the fuel cell relative to electrical demands incurred by the loads. In some instances, the fuel cell simultaneously powers one or more: a) electrical components in the fuel cell system, b) any external loads, and c) charge the battery. In a specific embodiment, the fuel cell operates at optimum fuel and air flow conditions as determined by the external loads. Since electrical demand will fluctuate slightly, reductions in load demands may be used as opportunities to charge a battery.

Continuous operation of a hybrid fuel cell system and maintenance of stoichiometric balance then proceeds. The hybrid control method then monitors one or more parameters that may indicate or lead to a potential stoichiometric disturbance in the fuel cell (310).

The hybrid fuel system operates such that during load transients, when the load(s) require greater energy than the existing steady state electrochemical conditions for the fuel cell, or when the fuel cell voltage drops in response to the change in load, the battery switches from charge mode and helps support the load while the fuel cell transitions to a new steady state condition. When the fuel cell has reached a new suitable stoichiometric or steady state operating condition, the battery switches back to charge mode in the fuel cell returns to powering the load(s).

In one embodiment, when the hybrid control system turns off the load or disconnects it from the fuel cell, the fuel cell continues to operate and recharge the battery. This ensures that the battery has sufficient charge to restart the fuel cell system, and also ensures that the battery can support the load at a later time if needed.

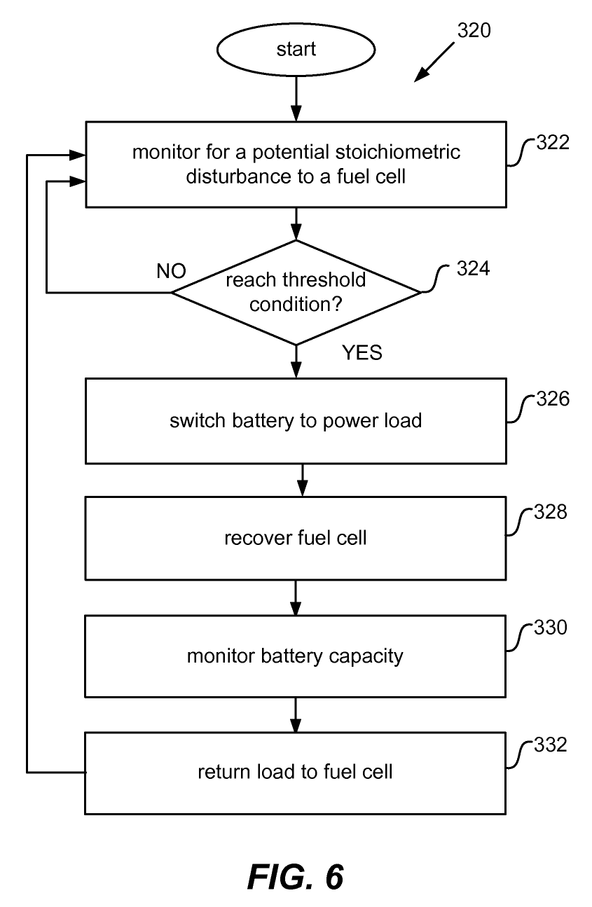

FIG. 6 shows a method 320 for operating a hybrid fuel cell system in accordance with one embodiment of the present invention.

Method 300 begins by detecting a parameter that may indicate a potential stoichiometric disturbance to a fuel cell (322). In one embodiment, the potential stoichiometric disturbance includes any chemical, electrical or physical event that may alter stoichiometric balance or electrical energy generation and chemical conversion in a fuel cell.

One or more sensors may be disposed in the fuel cell system or outlet lines to a load to monitor one or more such parameters. Suitable sensors may include current sensors, voltage sensors, temperature sensors, fuel sensors, etc. and will generally relate to the parameter being sensed.

Predetermined thresholds are set for each parameter being sensed. If a parameter meets a predetermined threshold (324), then the hybrid fuel cell system switches to battery power (326) and recovers the fuel cell (328).

Several exemplary parameters and thresholds that may trigger a switch to battery power in a hybrid fuel system will now be discussed. In one embodiment, the hybrid system monitors output current from a fuel cell and detects whether the current remains within acceptable limits. For example, most fuel cells have a maximum output current that they can support at a given steady state stoichiometry. For a PEM fuel cell, the maximum output current also relates to the size of the bipolar plates and is characterized by a maximum current per square centimeter. If the load demand requirement unexpectedly surpasses a threshold for the available current per square centimeter current availability (324), the battery assumes voltage and current provision to the load (326), thus protecting individual cells in the fuel cell from being driven to a state that compromises the efficiency and/or permanently damages the fuel cell.

In another embodiment, a sensor is added to an output voltage line of a fuel cell to monitor output voltage. A decreasing fuel cell output voltage may result from one or more losses (or polarizations), such as an activation loss, an ohmic loss and/or a mass transport loss. Any of these losses may reduce cell voltage for a cell in the stack to the point of potential damage. In general, cell performance drops as any one of the losses increases.

Mass transport losses relate to performance changes incurred by a fuel cell resulting from a deficiency in required reactants, and often occur during sudden or large electrical load increases. In one embodiment, a mass transport limitation is a point where the fuel cell design limits the amount of current and voltage that a stack can maintain in a steady state. A mass transport loss may also occur when the voltage drops very fast for small increases in voltage. Depending on the current and fuel/air flows, the mass transport limit can occur at lower loads, e.g., if the fuel cell is in an idle mode and suddenly receives a high load, a cell may be mass transport limited even at low current because the amount of fuel available at that time is low. This may result from, for example, sudden change in electrical load (and may be detected electrically as such). As an example: a stack operates at 1 amp; a control system for the fuel cell meters fuel and air in a desired stoichiometric ratio to provide enough reactants to generate the 1 amp. If the electrical load suddenly increases to 2 amps, oxygen and fuel available at the electro catalysts may deplete much faster than the control system is able to increase the fuel and air feed rates into the fuel cell (this may take several seconds, depending on the size of the fuel cell system). During this sudden electrical change, the fuel cell will be reactant starved and will experience mass transport polarization, until the fuel and air streams are increased and the reactants reach the anode and cathode in the fuel cell. Depending on the degree of reactant starvation, individual cells in the fuel cell stack may become over polarized and develop a negative voltage. If a cell operates for extended periods of time (several minutes) at a negative voltage, its catalyst may be permanently destroyed (typically the catalyst support corrodes away and reduces active area of the catalyst).

An ohmic loss refers to a change in the electrical performance of a fuel cell caused by ionic and/or electronic resistance changes. More specifically, ohmic losses may include resistance changes in the electrical path of the interfacial relationship of the current carrying medium in the bi-polar plates, GDL, and/or membrane. This relates to both the flow of electrons and the flow of protons in the system. For example, if one cell in a stack is operating at a higher temperature than its neighboring cell, voltage of the first cell may drop due to an increase in ohmic losses. Voltage for this cell may continue to drop until the cell goes negative, at which point the cell catalyst may become corroded and non-reactive. A temperature sensor configured within the fuel cell can detect the over-temperature condition. A controller configured to monitor section over temperature condition may then disconnect the fuel cell from the load until temperature stabilizes in the fuel cell.

A cell membrane may also locally overheat resulting from an increased heat load on the cell when the fuel cell operates at a low voltage while maintaining consistent power output by increasing the current requirement for the system. In PEM systems, this can lead to membrane dry-out and eventual gas crossover between the anode and cathode. In PAFC systems, this can lead to excessive acid loss rate for example. In general all fuel cell types (PAFC, PEM, AFC etc.) operate with a more uniform, or uniformly increasing or decreasing cell temperature. Unwanted hot spots typically lead to materials failures within an MEA. A temperature sensor may also detect and prevent this type of failure. A voltage sensor and/or a current sensor may also be used to detect the low-voltage and combined with suitable logic that determines what low voltage and/or what duration of low voltage triggers a switch to a battery.

Another form of loss relates to anode polarization, which includes voltage losses associated with excessive methanol or carbon monoxide presence, for example. Anode polarization may also arise from high hydrogen utilization, catalyst degradation etc. Anode polarization also relates to difficulties in transporting hydrogen to the catalyst, splitting the hydrogen into protons and electrons, and conducting the electrons away from the electrode.

Cathode polarization is also overcome by the present invention and relates to voltage losses associated with nitrogen dilution of oxygen in air. Generally, cathode polarization relates to difficulties in conducting protons and electrons to the catalyst, combining them with diluted oxygen from the air, converting them to steam, and/or then removing the steam from the catalyst site.

The present invention may trigger battery operation as a result of other thresholds or fuel cell system issues and is not limited to any specific failure within a fuel cell or fuel cell system, any particular stoichiometric disturbance, or a method of detecting the failure. Those with skill in the art are aware of other failure modes (and their parameters being monitored) that may occur within a fuel cell or fuel cell system, and that failure modes will vary based on the type of fuel cell or fuel cell system.

In some instances, the disturbance does not relate to a system failure. For example, if a user changes the fuel cartridge, this may lead to a disturbance for the inlet reactants (e.g., hydrogen) in the fuel cell. A sensor on the inlet fuel line or hydrogen sensor in the fuel cell can detect this disturbance (324). In this case, the hybrid fuel system switches from charge mode to support the output load(s), including the balance of plant electrical components for the fuel cell system (326) until the fuel provision recovers.

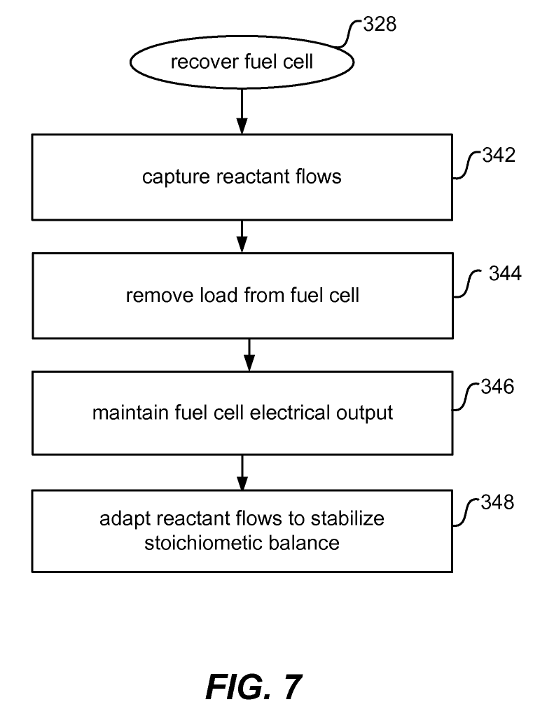

Once the battery starts powering the load, the fuel cell enters a recovery mode (328); one suitable recovery mode is described with respect to FIG. 7.

The battery stays in electrical support mode until the fuel cell returns to some predetermined operating state. At this time, fuel cell reassumes electrical energy provision (332) and the battery switches back to charge mode. A timer in a controller a processor for the hybrid fuel cell system may monitor battery capacity (330). The controller stores a maximum capacity for the battery and stores a current capacity for the battery based on its latest recharging and usage. The capacity may be converted into run time, which lets a user know how long the hybrid fuel system may continue on battery power.

FIG. 7 expands step 328 for recovering a fuel cell in accordance with one embodiment of the present invention. This typically begins when the hybrid fuel cell system disconnects the fuel cell from the load (344) and switches on the battery. At this time, the hybrid fuel system captures the latest reactants flows, such as the inlet hydrogen and oxygen flows provided to the fuel cell (342). Steps 342 and 344 may be switched in order. For example, the hybrid fuel cell system may store the reactant flow rates before it actually disconnects the load from the fuel cell.

The fuel cell then maintains a consistent electrical output, such as maintaining its output voltage at the time that the threshold voltage was reached (348). This gives the hybrid fuel cell system controller time to adapt the reactants flows to match the electric output (348). Thus, if the load suddenly increased electrical demands on the fuel cell, then the controller increases hydrogen and oxygen flow to the fuel cell proportional to the new electrical output. The controller may also alter other controlled rates in the fuel cell system. For a reformed methanol system for example, this includes increasing fuel flow to the fuel processor to increase hydrogen production.

The present invention permits a hybrid fuel cell system designer flexibly to determine when to switch to battery power. In one embodiment, a predetermined mathematical or logical relationship is used between a desired operating characteristic for the fuel cell and a switching threshold. For example, a lower voltage threshold may include some fraction of a desired operating voltage for the fuel cell, while an upper voltage threshold may include some multiple greater than the desired operating voltage.

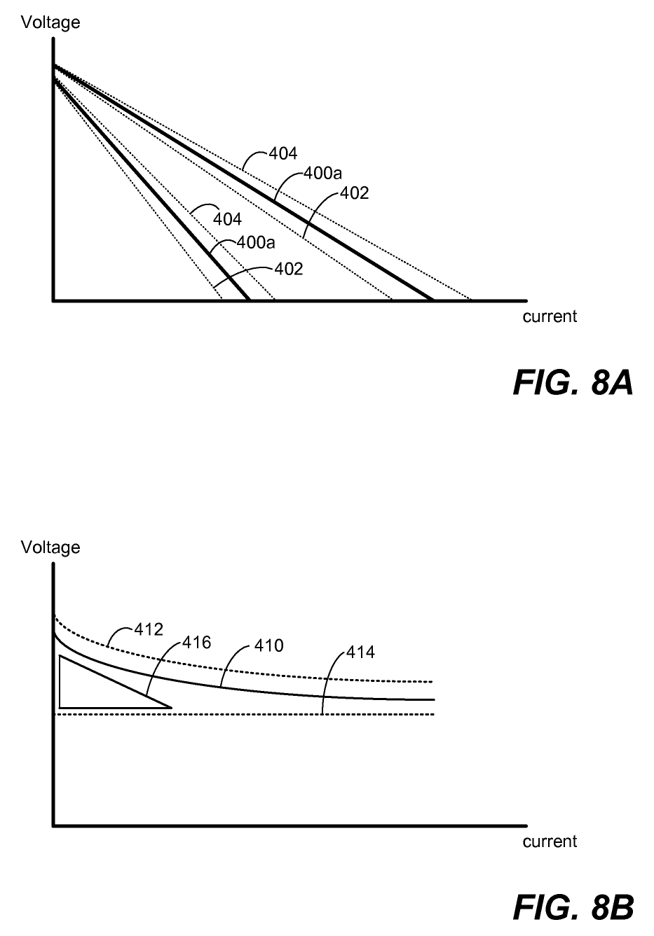

The upper and lower electrical thresholds may be established using one or more polarization curves for the fuel cell. A polarization curve refers to a representation of the electrical output for the fuel cell. FIG. 8A shows exemplary polarization curve 400 for a fuel cell in accordance with a specific embodiment of the present invention.

Each polarization curve 400a and 400b provides nominal voltage and current levels for the fuel cell. Each polarization curve 400 also includes a lower threshold 402 and an upper threshold 404. Load voltages and currents below lower threshold 402 will thus trigger the hybrid fuel cell system controller to engage the battery and disconnect the fuel cell. As shown in FIG. 8A, acceptable voltage for the fuel cell drops as current increases, and vice versa.

In this case, multiple polarization curves 400 are given to correspond to different times of the fuel cell life. For example, polarization curve 400a refers to the polarization curve used when the fuel cell is relatively new, while polarization curve 400b represents a polarization curve used when the fuel cell is older. As can be seen from polarization curves 400, acceptable voltage for the fuel cell typically decreases as the fuel cell ages. More than two polarization curves are suitable for use; and each curve 400 may be implemented according to a particular age of the fuel cell, e.g., as determined by operating lifetime of the fuel cell. The polarization curves 400, lower thresholds 402, and upper thresholds 404 may be stored in memory for easy access by a hybrid fuel cell system controller.

Different fuel cells (RMFC, SOFC, DMFC etc) will have different polarization curves. A polarization curve may also depend on mechanical layout of the fuel cell system, materials selection in the fuel cell, and/or operating conditions seen by the fuel cell stack. Also, since each cell in a stack may witness different operating conditions, each cell may have its own voltage at a given current. In some cases, a polarization curve shifts during transient conditions (such as varying current, temperature and reactant stoichiometries etc.).

Other polarization curves may be used. Some curves may be built based on system testing and user designation and need not be linear or simple. FIG. 8B shows another exemplary polarization curve 410 that compensates for low-voltage usage in accordance with a specific embodiment of the present invention.

Polarization curve 410 includes an upper threshold 412 and a lower threshold 414. Lower threshold 414 also includes buffering 416 that additionally protects the fuel cell at low current levels. More specifically, buffering 416 allows a fuel cell system designer to vary upper or lower thresholds according to specific performance characteristics of a fuel cell. In this case, the fuel cell does not perform as well at low current (or voltage) and buffering 416 protects the fuel cell in this performance regime.

A fuel cell system suitable for use with the present invention will now be described. Other fuel cells and fuel cell systems are suitable for use with the present invention. FIG. 9A illustrates an exemplary fuel cell system 10 for producing electrical energy in accordance with one embodiment of the present invention. The ‘reformed’ hydrogen system 10 processes a fuel 17 to produce hydrogen for supply to fuel cell 20. As shown, the reformed hydrogen supply includes a fuel processor 15 and a fuel storage device 16.

Storage device 16 (or ‘cartridge’) stores a fuel 17, and may comprise a refillable and/or disposable fuel cartridge. Either design permits recharging capability for a fuel cell system or electronics device by swapping a depleted cartridge for one with fuel. A connector on the cartridge 16 interfaces with a mating connector on an electronics device or portable fuel cell system to permit fuel to be withdrawn from the cartridge. In one embodiment, the cartridge includes a bladder that contains the fuel and conforms to the volume of fuel in the bladder. An outer rigid housing provides mechanical protection for the bladder. The bladder and housing permit a wide range of portable and non-portable cartridge sizes with fuel capacities ranging from a few milliliters to several liters. In one embodiment, the cartridge is vented and includes a small hole, single direction flow valve, hydrophobic filter, or other aperture to allow air to enter the fuel cartridge as fuel 17 is consumed and displaced from the cartridge. This type of cartridge allows for “orientation” independent operation since pressure in the bladder remains relatively constant as fuel is displaced. A pump may draw fuel 17 from the fuel storage device 16. Cartridges may also be pressurized with a pressure source such as foam or a propellant internal to the housing that pushes on the bladder (e.g, propane or compressed nitrogen gas). Other fuel cartridge designs suitable for use herein may include a wick that moves a liquid fuel from locations within a fuel cartridge to a cartridge exit. In another embodiment, the cartridge includes ‘smarts’, or a digital memory used to store information related to usage of the fuel cartridge.

A pressure source (FIG. 9B) moves the fuel 17 from cartridge 16 to fuel processor 15. Exemplary pressure sources include pumps, pressurized sources internal to the cartridge (such as a compressible foam or spring) that employ a control valve to regulate flow, etc. In one embodiment, a diaphragm pump controls fuel 17 flow from storage device 16. If system 10 is load following, then a control system meters fuel 17 flow to deliver fuel to processor 15 at a flow rate determined by a required power level output of fuel cell 20 and regulates a controlled item accordingly.

Fuel 17 acts as a carrier for hydrogen and can be processed or manipulated to separate hydrogen. As the terms are used herein, ‘fuel’, ‘fuel source’ and ‘hydrogen fuel source’ are interchangeable and all refer to any fluid (liquid or gas) that can be manipulated to separate hydrogen. Fuel 17 may include any hydrogen bearing fuel stream, hydrocarbon fuel or other source of hydrogen such as ammonia. Currently available hydrocarbon fuels 17 suitable for use with the present invention include gasoline, C₁ to C₄ hydrocarbons, their oxygenated analogues and/or their combinations, for example. Other fuel sources may be used with a fuel cell package of the present invention, such as sodium borohydride. Several hydrocarbon and ammonia products may also be used. Liquid fuels 17 offer high energy densities and the ability to be readily stored and shipped.

Fuel 17 may be stored as a fuel mixture. When the fuel processor 15 comprises a steam reformer, for example, storage device 16 includes a fuel mixture of a hydrocarbon fuel and water. Hydrocarbon fuel/water mixtures are frequently represented as a percentage of fuel in water. In one embodiment, fuel 17 comprises methanol or ethanol concentrations in water in the range of 1-99.9%. Other liquid fuels such as butane, propane, gasoline, military grade “JP8”, etc. may also be contained in storage device 16 with concentrations in water from 5-100%. In a specific embodiment, fuel 17 comprises 67% methanol by volume.

Fuel processor 15 processes fuel 17 and outputs hydrogen. In one embodiment, a hydrocarbon fuel processor 15 heats and processes a hydrocarbon fuel 17 in the presence of a catalyst to produce hydrogen. Fuel processor 15 comprises a reformer, which is a catalytic device that converts a liquid or gaseous hydrocarbon fuel 17 into hydrogen and carbon dioxide. As the term is used herein, reforming refers to the process of producing hydrogen from a fuel 17. Fuel processor 15 may output either pure hydrogen or a hydrogen bearing gas stream (also commonly referred to as ‘reformate’).

Various types of reformers are suitable for use in fuel cell system 10; these include steam reformers, auto thermal reformers (ATR) and catalytic partial oxidizers (CPOX) for example. A steam reformer only needs steam and fuel to produce hydrogen. ATR and CPOX reformers mix air with a fuel/steam mixture. ATR and CPOX systems reform fuels such as methanol, diesel, regular unleaded gasoline and other hydrocarbons. In a specific embodiment, storage device 16 provides methanol 17 to fuel processor 15, which reforms the methanol at about 300° C. or less and allows fuel cell system 10 usage in low temperature applications.

Fuel cell 20 electrochemically converts hydrogen and oxygen to water, generating electrical energy (and sometimes heat) in the process. Ambient air readily supplies oxygen. A pure or direct oxygen source may also be used. The water often forms as a vapor, depending on the temperature of fuel cell 20. For some fuel cells, the electrochemical reaction may also produce carbon dioxide as a byproduct.

In one embodiment, fuel cell 20 is a low volume ion conductive membrane (PEM) fuel cell suitable for use with portable applications such as consumer electronics. A PEM fuel cell comprises a membrane electrode assembly (MEA) that carries out the electrical energy generating an electrochemical reaction. The MEA includes a hydrogen catalyst, an oxygen catalyst, and an ion conductive membrane that a) selectively conducts protons and b) electrically isolates the hydrogen catalyst from the oxygen catalyst. A hydrogen gas distribution layer may also be included; it contains the hydrogen catalyst and allows the diffusion of hydrogen therethrough. An oxygen gas distribution layer contains the oxygen catalyst and allows the diffusion of oxygen and hydrogen protons therethrough. Typically, the ion conductive membrane separates the hydrogen and oxygen gas distribution layers. In chemical terms, the anode comprises the hydrogen gas distribution layer and hydrogen catalyst, while the cathode comprises the oxygen gas distribution layer and oxygen catalyst.

In one embodiment, a PEM fuel cell includes a fuel cell stack having a set of bi-polar plates. In one embodiment, each bi-polar plate is formed from a single sheet of metal that includes channel fields on opposite surfaces of the metal sheet. Thickness for these plates is typically below about 5 millimeters, and compact fuel cells for portable applications may employ plates thinner than about 2 millimeters. The single bi-polar plate thus dually distributes hydrogen and oxygen: one channel field distributes hydrogen while a channel field on the opposite surface distributes oxygen. In another embodiment, each bi-polar plate is formed from multiple layers that include more than one sheet of metal.

Multiple bi-polar plates can be stacked to produce the ‘fuel cell stack’ in which a membrane electrode assembly is disposed between each pair of adjacent bi-polar plates. Gaseous hydrogen distribution to the hydrogen gas distribution layer in the MEA occurs via a channel field on one plate while oxygen distribution to the oxygen gas distribution layer in the MES occurs via a channel field on a second plate on the other surface of the membrane electrode assembly.

In electrical terms, the anode includes the hydrogen gas distribution layer, hydrogen catalyst and a bi-polar plate. The anode acts as the negative electrode for fuel cell 20 and conducts electrons that are freed from hydrogen molecules so that they can be used externally, e.g., to power an external circuit or stored in a battery. In electrical terms, the cathode includes the oxygen gas distribution layer, oxygen catalyst and an adjacent bi-polar plate. The cathode represents the positive electrode for fuel cell 20 and conducts the electrons back from the external electrical circuit to the oxygen catalyst, where they can recombine with hydrogen ions and oxygen to form water.

In a fuel cell stack, the assembled bi-polar plates are connected in series to add electrical potential gained in each layer of the stack. The term ‘bi-polar’ refers electrically to a bi-polar plate (whether mechanically comprised of one plate or two plates) sandwiched between two membrane electrode assembly layers. In a stack where plates are connected in series, a bi-polar plate acts as both a negative terminal for one adjacent (e.g., above) membrane electrode assembly and a positive terminal for a second adjacent (e.g., below) membrane electrode assembly arranged on the opposite surface of the bi-polar plate.

In a PEM fuel cell, the hydrogen catalyst separates the hydrogen into protons and electrons. The ion conductive membrane blocks the electrons, and electrically isolates the chemical anode (hydrogen gas distribution layer and hydrogen catalyst) from the chemical cathode. The ion conductive membrane also selectively conducts positively charged ions. Electrically, the anode conducts electrons to a load (electrical energy is produced) or battery (energy is stored). Meanwhile, protons move through the ion conductive membrane. The protons and used electrons subsequently meet on the cathode side, and combine with oxygen to form water. The oxygen catalyst in the oxygen gas distribution layer facilitates this reaction. One common oxygen catalyst comprises platinum powder thinly coated onto a carbon paper or cloth. Many designs employ a rough and porous catalyst to increase surface area of the platinum exposed to the hydrogen and oxygen.

Since the electrical generation process in fuel cell 20 is exothermic, fuel cell 20 may implement a thermal management system to dissipate heat. Fuel cell 20 may also employ a number of humidification plates (HP) to manage moisture levels in the fuel cell.

While the present invention will mainly be discussed with respect to PEM fuel cells, it is understood that the present invention may be practiced with other fuel cell architectures. The main difference between fuel cell architectures is the type of ion conductive membrane used. In another embodiment, fuel cell 20 is phosphoric acid fuel cell that employs liquid phosphoric acid for ion exchange. Solid oxide fuel cells (SOFC) employ a hard, non-porous ceramic compound for ion exchange and may be suitable for use with the present invention. Generally, any fuel cell architecture may be applicable to the hybrid fuel cell systems described herein. Other such fuel cell architectures include direct methanol fuel cells, or alkaline and molten carbonate fuel cells, for example.

FIG. 9B illustrates schematic operation for the fuel cell system 10 of FIG. 9A in accordance with a specific embodiment of the present invention.

Fuel storage device 16 stores methanol or a methanol mixture as a hydrogen fuel 17. An outlet of storage device 16 includes a connector 23 that mates with a mating connector on a package 11. In this case, the package 11 includes the fuel cell 20, fuel processor 15, and all other balance-of-plant components except the cartridge 16. In a specific embodiment, the connector 23 and mating connector form a quick connect/disconnect for easy replacement of cartridges 16. The mating connector communicates methanol 17 into hydrogen fuel line 25, which is internal to package 11 in this case.

Line 25 divides into two lines: a first line 27 that transports methanol 17 to a heater/heater 30 for fuel processor 15 and a second line 29 that transports methanol 17 for a reformer 32 in fuel processor 15. Lines 25, 27 and 29 may comprise channels disposed in the fuel processor (e.g., channels in metals components) and/or tubes leading thereto.

Flow control is provided on each line 27 and 29. Separate pumps 21a and 21b are provided for lines 27 and 29, respectively, to pressurize each line separately and transfer methanol at independent rates, if desired. A model 030SP-S6112 pump as provided by Biochem, NJ is suitable to transmit liquid methanol on either line in a specific embodiment. A diaphragm or piezoelectric pump is also suitable for use with system 10. A flow restriction may also provided on each line 27 and 29 to facilitate sensor feedback and flow rate control. In conjunction with suitable control, such as digital control applied by a processor that implements instructions from stored software, each pump 21 responds to control signals from the processor and moves a desired amount of methanol 17 from storage device 16 to heater 30 and reformer 32 on each line 27 and 29. In another specific embodiment shown, line 29 runs inlet methanol 17 across or through a heat exchanger that receives heat from the exhaust of the heater 30 in fuel processor 15. This increases thermal efficiency for system 10 by preheating the incoming fuel (to reduce heating of the fuel in heater 30) and recuperates heat that would otherwise be expended from the system.

Air source 41 delivers oxygen and air from the ambient room through line 31 to the cathode in fuel cell 20, where some oxygen is used in the cathode to generate electricity. Air source 41 may include a pump, fan, blower or compressor, for example. High operating temperatures in fuel cell 20 also heat the oxygen and air.

In the embodiment shown, the heated oxygen and air is then transmitted from the fuel cell via line 33 to a regenerator 36 (also referred to herein as a ‘dewar’) of fuel processor 15, where the air is additionally heated (by the heater, while in the dewar) before entering heater 30. This double pre-heating increases efficiency of the fuel cell system 10 by a) reducing heat lost to reactants in heater 30 (such as fresh oxygen that would otherwise be near room temperature when combusted in the heater), and b) cooling the fuel cell during energy production. In this embodiment, a model BTC compressor as provided by Hargraves, NC is suitable to pressurize oxygen and air for fuel cell system 10.

A fan 37 blows cooling air (e.g., from the ambient room) over fuel cell 20. Fan 37 may be suitably sized to move air as desired by heating requirements of the fuel cell; and many vendors known to those with skill in the art provide fans suitable for use with package 10.

Fuel processor 15 receives methanol 17 and outputs hydrogen. Fuel processor 15 comprises heater 30, reformer 32, boiler 34 and regenerator 36. Heater 30 (also referred to herein as a burner when it uses catalytic combustion to generate heat) includes an inlet that receives methanol 17 from line 27. In a specific embodiment, the burner includes a catalyst that helps generate heat from methanol. In another embodiment, heater 30 also includes its own boiler to preheat fuel for the heater.

Boiler 34 includes a boiler chamber having an inlet that receives methanol 17 from line 29. The boiler chamber is configured to receive heat from heater 30, via heat conduction through walls in monolithic structure 100 between the boiler 34 and heater 30, and use the heat to boil the methanol passing through the boiler chamber. The structure of boiler 34 permits heat produced in heater 30 to heat methanol 17 in boiler 34 before reformer 32 receives the methanol 17. In a specific embodiment, the boiler chamber is sized to boil methanol before receipt by reformer 32. Boiler 34 includes an outlet that provides heated methanol 17 to reformer 32.

Reformer 32 includes an inlet that receives heated methanol 17 from boiler 34. A catalyst in reformer 32 reacts with the methanol 17 to produce hydrogen and carbon dioxide; this reaction is endothermic and draws heat from heater 30. A hydrogen outlet of reformer 32 outputs hydrogen to line 39. In one embodiment, fuel processor 15 also includes a preferential oxidizer that intercepts reformer 32 hydrogen exhaust and decreases the amount of carbon monoxide in the exhaust. The preferential oxidizer employs oxygen from an air inlet to the preferential oxidizer and a catalyst, such as ruthenium or platinum that is preferential to carbon monoxide over hydrogen.

Regenerator 36 pre-heats incoming air before the air enters heater 30. In one sense, regenerator 36 uses outward traveling waste heat in fuel processor 15 to increase thermal management and thermal efficiency of the fuel processor. Specifically, waste heat from heater 30 pre-heats incoming air provided to heater 30 to reduce heat transfer to the air within the heater. As a result, more heat transfers from the heater to reformer 32. The regenerator also functions as insulation for the fuel processor. More specifically, by reducing the overall amount of heat loss from the fuel processor, regenerator 36 also reduces heat loss from package 10 by heating air before the heat escapes fuel processor 15. This reduces heat loss from fuel processor 15, which enables cooler fuel cell system 10 packages.

Line 39 transports hydrogen (or ‘reformate’) from fuel processor 15 to fuel cell 20. In a specific embodiment, gaseous delivery lines 33, 35 and 39 include channels in a metal interconnect that couples to both fuel processor 15 and fuel cell 20. A hydrogen flow sensor (not shown) may also be added on line 39 to detect and communicate the amount of hydrogen being delivered to fuel cell 20. In conjunction with the hydrogen flow sensor and suitable control, such as digital control applied by a processor that implements instructions from stored software, fuel processor 15 regulates hydrogen gas provision to fuel cell 20.

Fuel cell 20 includes a hydrogen inlet port that receives hydrogen from line 39 and includes a hydrogen intake manifold that delivers the gas to one or more bi-polar plates and their hydrogen distribution channels. An oxygen inlet port of fuel cell 20 receives oxygen from line 31; an oxygen intake manifold receives the oxygen from the port and delivers the oxygen to one or more bi-polar plates and their oxygen distribution channels. A cathode exhaust manifold collects gases from the oxygen distribution channels and delivers them to a cathode exhaust port and line 33, or to the ambient room. An anode exhaust manifold 38 collects gases from the hydrogen distribution channels, and in one embodiment, delivers the gases to the ambient room.

In the embodiment shown, the anode exhaust is transferred back to fuel processor 15. In this case, system 10 comprises plumbing 38 that transports unused hydrogen from the anode exhaust to heater 30. For system 10, heater 30 includes two inlets: an inlet configured to receive fuel 17 and an inlet configured to receive hydrogen from line 38. In one embodiment, gaseous delivery in line 38 back to fuel processor 15 relies on pressure at the exhaust of the anode gas distribution channels, e.g., in the anode exhaust manifold. In another embodiment, an anode recycling pump or fan is added to line 38 to pressurize the line and return unused hydrogen back to fuel processor 15.

In one embodiment, fuel cell 20 includes one or more heat transfer appendages 46 that permit conductive heat transfer with internal portions of a fuel cell stack. In a specific heating embodiment as shown, exhaust of heater 30 in fuel processor 15 is transported to the one or more heat transfer appendages 46 in fuel cell 20 during system start-up to expedite reaching initial elevated operating temperatures in the fuel cell 20. The heat may come from hot exhaust gases or unburned fuel in the exhaust, which then interacts with a catalyst disposed in proximity to a heat transfer appendage 46. In a specific cooling embodiment, an additional fan 37 blows cooling air over the one or more heat transfer appendages 46, which provides dedicated and controllable cooling of the stack during electrical energy production.

In addition to the components shown in shown in FIG. 9B, system 10 may also include other elements such as electronic controls, additional pumps and valves, added system sensors, manifolds, heat exchangers and electrical interconnects useful for carrying out functionality of a fuel cell system 10 that are known to one with skill in the art and omitted for sake of brevity. FIG. 9B shows one specific plumbing arrangement for a fuel cell system; other plumbing arrangements are suitable for use herein. For example, the heat transfer appendages 46, a heat exchanger and dewar 36 need not be included. Other alterations to system 10 are permissible, as one with skill in the art will appreciate.

The present invention is well suited for use with micro fuel cell systems. A micro fuel cell system generates dc voltage, and may be used in a wide variety of applications. For example, electrical energy generated by a micro fuel cell may power a notebook computer 11 or a portable electrical generator 11 carried by military personnel. In one embodiment, the present invention provides ‘small’ fuel cells that are configured to output less than 200 watts of power (net or total). Fuel cells of this size are commonly referred to as ‘micro fuel cells’ and are well suited for use with portable electronics devices. In one embodiment, the fuel cell is configured to generate from about 1 milliwatt to about 200 Watts. In another embodiment, the fuel cell generates from about 5 Watts to about 60 Watts. Fuel cell system 10 may be a stand-alone system, which is a single package 11 that produces power as long as it has access to a) oxygen and b) hydrogen or a hydrogen source such as a hydrocarbon fuel. One specific portable fuel cell package produces about 20 Watts or about 45 Watts, depending on the number of cells in the stack.

The hybrid fuel cell systems described herein may flexibly link a fuel cell system and an electronics device. In one embodiment, the fuel cell system is included in a portable fuel cell package that externally couples to an electronics device. Further description of portable fuel cell packages suitable for use with the present invention is provided in commonly owned and co-pending patent application Ser. No. 11/120,643 and entitled ‘COMPACT FUEL CELL PACKAGE’, which is incorporated by reference herein in its entirety for all purposes. In one embodiment, the fuel cell system couples to an external port of the electronics device, such as the AC adapter in a laptop computer. Other electrical connections between a fuel cell system and electronics device are also contemplated.

Most commercially available laptop computers are powered by on-board batteries or by an external power adaptor. Typically, the power adaptor is rated at a certain power level sufficient to both power the laptop and provide extra power to charge the laptop batteries. If a power adaptor is present and the laptop is off or in sleep mode, then all the power adaptor power is directed to charge the batteries.

There is a power limit that can be used to charge a battery. This power limit is a function of the energy storage rating of the battery, its maximum allowable charge rate and other factors such as ambient temperature and the temperature of the battery pack. Generally, the charging power will be reduced if the above temperatures are high (greater than 50 degrees Celsius) in order to prevent damage to the batteries. An industry standard is the “C” rating of the battery (amp-hour capacity: Ahr.) Modern LiIon laptop batteries (such as 18650 dimensions) have a “C” rating over 2 Ahr and an average voltage of ˜3.75V. Therefore, a single battery is typically charged at a maximum rate of 8.4 W, or 2 A @ 4.2V. Some laptop manufactures charge their batteries at 2 C ie 16.8 W, or 4 A @ 4.2V. An average typical rate of charge is between 1-2 C. Typical power adaptors have a power rating of 45-90 W, depending on the laptop manufacturer and the size of the on-board battery pack.

This affects fuel cell system design for a fuel that externally powers a portable computer through the AC port. When connected to a power adaptor or power port of a laptop computer or other electronics device, the computer is programmed to use all available power from the adapter and fuel cell. Thus, if the power adaptor is rated at 60 W and the laptop is using 20 W to operate, then 40 W will be directed to the battery pack for charging. When a fuel cell connects to the power port of the laptop under these operating conditions, it needs to provide 60 W. This means that the fuel cell must be sized for 60 W, even though it is only providing an average of 20 W to power the laptop. Increasing the power of the fuel cell from 20 W to 60 W increases the cost & complexity of the fuel cell, particularly a portable fuel cell system.

In one embodiment, a hybrid fuel cell system couples to an electronics device in a manner that reduces power requirements for a fuel cell system.

Laptops and other portable electronics devices often include power management schemes and systems that help an electronics device run longer on rechargeable batteries. In one embodiment, a hybrid fuel cell system uses, or intimately cooperates with, a power management system on an electronics device. In general, a power management system, such as an SMBus or SBS system, refers to a power and communications system within an electronics device that provides power management and electrical power communication in the electronics device.

To simplify discussion, a power management scheme suitable for use with the present invention will now be described with reference to the SMBus (System Management Bus) and Smart Battery Data Set standard. Other power management schemes and systems are known in the art and also suitable for use with a hybrid fuel cell system of the present invention.

The SMBus permits a host device to harvest data and information from smart batteries (such as Li Ion batteries) that include and access an onboard PCB containing a smart battery integrated circuit (IC), amongst other devices. These smart battery ICs calculate up to 34 status data items on a continuous basis. Communicated through the SMBus, this data may be used by a computer's BIOS system and the operating system to orchestrate power utilization within a portable computer or other electronics device. The electronics device can then manage battery power and the discharge of the battery in a dynamic way so as to maximize run time on the limited battery energy supply.

In one embodiment to gain access to this power management functionality and improve a hybrid fuel cell system, the hybrid fuel cell system accesses the SMBus. In a specific embodiment, the fuel cell is internal to the portable computer and couples to internal connectors for the SMBus. Part of SMBus Standard specifies electrical interconnection between a battery and host device. This known interconnect is then used to adapt an internal fuel cell to communicate with the SMBus, e.g., in place of a battery in the battery bay of a laptop computer.

In another embodiment, the fuel cell couples through a passthrough battery that is configured for use in a battery bay of a laptop computer or other portable electronics device. FIG. 10A illustrates a passthrough battery 500 situated in the battery bay of a laptop computer 505 in accordance with one embodiment of the present invention. FIG. 10B shows internal components of passthrough battery 500 and laptop computer 505 in accordance with a specific embodiment of the present invention.

Passthrough battery 500 couples to fuel cell system 10 and to an internal SMBus connection 518 in portable computer 505. An external port 514 on passthrough battery 500 permits external detachable coupling to a fuel cell system 10. For example, fuel cell system 10 includes a tether 515 (an electrical connect) that permits detachably coupling with mating port 514 on an external surface 516 of passthrough battery 500. Passthrough battery 500 then internally connects to and communicates with the SMBus connection 518 (FIG. 10B) and provides electrical interconnect between the external fuel cell system 10 and internal SMBus connection 518. Since connection 518 is buried within computer 505 as part of the connection in an internal battery bay sized to receive a conventional battery, this embodiment provides a means of routing the SMBus terminals 518 to the outside of a battery pack. In this case, the fuel cell rests external to the laptop computer 505 while wiring in passthrough battery 500 runs from SMBus connection 518 internal to computer 505 to port 514 outside the laptop 505 and to the external fuel cell system 10.

The remaining disclosure will now focus on a tethered fuel cell system and passthrough battery 500. It will be understood that the remaining hybrid connectivity and power management disclosure applies to a fuel cell internal to the laptop (e.g., sized to fit in the battery bay). In addition, although the remaining disclosure will now focus on connecting to a portable computer, other electronics devices and computer systems may benefit from connectivity and hybrid fuel cell power coupling described herein, as one with skill in the art will appreciate. Such electronics devices may include any device including a power management bus such as a SMBus connection or any device that operates using power provided by a rechargeable battery.

In a specific embodiment, passthrough battery 500 employs a commercially available battery pack (such as a rechargeable and removable battery) used with a commercially available laptop computer, removes one or more cells from the battery pack to free space, and then adds a wiring harness 502.

Wiring harness 502 (FIG. 10B) travels from a SMBus connector 504 on the passthrough battery 500, which interfaces with the SMBus connector 518 in the computer, through the battery 500 to external port 504. Wiring harness 502 thus traverses the battery pack from: a) a first surface or wall of the battery pack that mechanically couples to a power Bus connector in the laptop, or an intermediate connector that communicates with the power Bus connector in the laptop, to b) a second surface or wall of the battery pack that permits external mechanical and electrical coupling to a fuel cell system 10 that is external to the laptop computer 505. This creates a power bus connector 514 on an external surface of passthrough battery 500, and allows a tethered fuel cell system 10 to detachably connect to the external power Bus connector 514 on the outside of battery 500.

Wiring harness 502 includes any circuitry required for interface between fuel cell system 10, batteries 512 and laptop computer 505. For example, wiring harness 502 may include one or more DC-DC converters for power conversion between the fuel cell and system 10 and acceptable levels for the SMBus. Wiring harness 502 may also include a controller or processor configured to provide hybrid fuel cell power management as described above, such as controller 102 of FIG. 1B. The controller is designed to manage fuel cell output between the laptop 505 and batteries 512 as needed, depending on the state of charge of batteries 512 and the laptop computer 505 power requirements. If computer 505 requires all the fuel cell electrical power output, then wiring harness 502 directs electrical power output from the fuel cell to the laptop computer 505. If the computer is off or needs less power than currently provided by the fuel cell, then wiring harness 502 directs electrical power output from the fuel cell to batteries 512. If computer 505 power exceeds the output of the fuel cell in system 10, then the controller load shares between the fuel cell and batteries 512 to deliver the required power to the laptop. In the case where the laptop power exceeds the fuel cell output, the converter may also turn off the fuel cell output, and direct the laptop power to be supplied by the battery, as described above in FIGS. 5-7.

Passthrough battery 500 includes at least one battery cell 512. Hybrid fuel cell control as described above uses battery cells 512 in pass through battery 500 pack. Battery cells 512 may include suitably sized commercially available batteries which are available from a wide variety of vendors known to those with skill in the art.

In one embodiment, a balancing circuit is added in the vacant space in the battery. The balancing circuit allows for different output rated fuel cells to power devices, by-passing the DC-in portion of the devices power management circuit. For example, a laptop computer may have a 65 W power adaptor. If a 25 W fuel cell is connected to the adaptor, the fuel cell will continually “trip” and load will be supplied by the hybrid system, eventually leaving the batteries drained. Laptop manufacturers typically offer different sized power adaptors, and some sort of encoding is included in the power adaptor cable, e.g., a certain resistance in the connector may tell a laptop computer what power level the adaptor is rated at, and the computer will power manage itself to that rating. By connecting directly to a power bus on a laptop battery jack, different sized fuel cells can be used with laptops, regardless of the power adaptor rating. By modulating the battery charging power, the fuel cell system can provide power to the laptop internals first, and charge the batteries once the internal load is met. For example, one portable computer consumes an average of 12 W, yet it is provided with a 45 W adaptor. By tying the fuel cell into the battery bay connection, the battery charging can be modulated to the max rating of the fuel cell power minus any load that the laptop computer internals currently use. This allows for replacement of 45 W AC adaptor with a 20 W fuel cell for example.

Connecting to power bus connector 518 allows the fuel cell system to bypass the power requirements on an external AC power port—and permits lower power fuel cell systems to be used. For example, by gaining access to a SMBus connector 518, fuel cell system 10 may drop from 45-60 W (as needed when coupling to an AC power adaptor for computer 505) to about 15-25 W when coupling to the SMBus connector 518. This reduces size and cost of fuel cell system 10. The exact power requirements will vary. Laptop computer power breakdown varies with manufacturer and models offered by the manufacturer. Many “business” oriented laptop computers consume an average of about 25 W. Smaller models consume an average of about 15 W, while desktop replacements can consume an average of up to 40 W. In general, each of the different laptop models frequently requires short power bursts of about 2 times the average power: hard drives spinning up, intensive calculations etc. In a fuel cell powered laptop, such power bursts may be accommodated in a hybrid power arrangement as described above.

Access to the SMBus connector 518 also allows fuel cell system 10 and computer 505 to communicate over the SMbus for intelligent power management. This allows BIOS control of the hybrid battery/fuel cell system, and also permits control according to operating system requirements (ACPI). This also allows power management 525 on the computer to communicate with a controller for the fuel cell system to share knowledge of upcoming power demands (e.g., the user just initiated a DVD) to help the fuel cell system controller better manage the fuel cell system.

Passthrough battery 500 thus provides a hybrid battery that provides both rechargeable DC power and electricity generated by a fuel cell in system 10. Power from the fuel cell may be used to replenish the rechargeable battery, as described above. OEMs such as laptop manufacturers may provide a passthrough battery 500 as an accessory, which is useful to permit fuel cell usage with commercially available laptop computers with no internal hardware changes.

Electrical power provided to the laptop is used to power various sub-systems 520 in the laptop. Power consumption for the laptop computer 505 may include power consumed by a display, CPU, chipset, clock, one or more interfaces such as a CD reader or CD burner, audio output, a fan, etc.

As mentioned above, a commercially available battery pack may be modified by removing one or more batteries to make space for wiring harness 502. The number of batteries removed depends on design features of the battery pack, such as the voltage layout of the pack. For example if there are six batteries in the pack wired in 3S2P (3 series, 2 parallel), then three of the batteries can be removed resulting in a 3S1P (3 series) pack; thus leaving the battery pack to provide dc electrical energy at the same voltage. Other battery configurations are contemplated and suitable for use with connectors described herein.

The computer 505, fuel cell system 10, or a combination thereof, may provide power management and control for the hybrid system. In one embodiment, power management 525 on the computer regulates the hybrid fuel cell power system and controls power provision by fuel cell system 10 and electrochemical batteries 512. Thus, power management 525 may inform a controller for the fuel cell system how much power is needed for laptop computer 505 operation and the fuel cell system controller responds by sending signals to the fuel cell, fuel processor and a pump that draws fuel from the fuel cartridge to alter fuel cell power production accordingly.

In another embodiment, passthrough battery 500 is designed directly into laptop computer 505 as an OEM design. In this case, the OEM designs fuel cell capability into the product.

In another embodiment, the fuel cell tether 515 connects into the AC adapter of the laptop computer 505, the two connectors share a power port (or jack), and the computer is configured to determine whether the line coupled to the port is an AC adaptor or a fuel cell, and operate accordingly. Each AC or fuel cell tether cable may be wired such that the converter board and power management systems know whether the input is a fuel cell or a power cable. This may be accomplished using resistive encoding of the cables, for example. If the input is an AC power adaptor, then the power draw and power sharing on the laptop computer is similar to that used in conventional laptops. If the input is a fuel cell, then the power management and sharing operates as outlined above.

While the hybrid fuel cell system has been primarily described as systems and methods, those skilled in the area will recognize that the present invention encompasses software having units capable of performing the actions as described below. Because such actions may be implemented as program instructions, the present invention also relates to machine-readable media that include program instructions, state information, etc. for performing various operations of controlling a hybrid fuel cell system. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory (ROM) devices and random access memory (RAM) devices. Examples of program instructions include both machine code, such as produced by a compiler, and files containing higher level code that may be executed by the computer using an interpreter. Other forms of machine-readable media are also suitable for use.

While this invention has been described in terms of several preferred embodiments, there are alterations, permutations, and equivalents that fall within the scope of this invention which have been omitted for brevity's sake. For example, although the present invention has described fuel processors in portable fuel cell systems, it is not related to small or portable systems. In addition, heating systems have been described with respect to fuel cells that include heat transfer appendages. It is understood that the present invention need not include one or more heat transfer appendages. It is therefore intended that the scope of the invention should be determined with reference to the appended claims.

What is claimed is:

1. A method of operating a portable electrical power source, the method comprising:
generating electrical energy in a fuel cell;
providing the fuel cell electrical energy to a load;
detecting a potential stoichiometric disturbance for the fuel cell;
in response to detecting the potential stoichiometric disturbance, electrically initiating a secondary electrical energy source to provide electrical energy to the load;
recording a flow rate of oxygen and a flow rate of hydrogen to the fuel cell;
in response to detecting the potential stoichiometric disturbance, electrically disconnecting the fuel cell from the load;
maintaining oxygen flow and hydrogen flow to the fuel cell while the secondary electrical energy source provides electrical energy to the load and while the fuel cell is electrically disconnected from the load; and
altering the flow rate of oxygen or the flow rate of hydrogen according to an electrical state of the load.
